(19) United States
(12) Patent Application Publication
(10) Pub. No.: US 2018/0272813 A1
(43) Pub. Date: Sep. 27, 2018

(54) MODEL BASED TIRE WEAR ESTIMATION SYSTEM AND METHOD

(71) Applicant: The Goodyear Tire & Rubber Company, Akron, OH (US)

(72) Inventor: Kanwar Bharat Singh, Lorenztweiler (LU)

(21) Appl. No.: 15/909,288

(22) Filed: Mar. 1, 2018

Related U.S. Application Data
(60) Provisional application No. 62/475,353, filed on Mar. 23, 2017.

(51) Int. Cl. B60C 11/24; B60C 19/00

(52) U.S. Cl. CPC B60C 11/246; B60C 2019/004; B60C 19/00; B60C 11/243

(57) ABSTRACT

A tire wear estimation system is provided. The system includes at least one tire that supports a vehicle. At least one sensor is affixed to the tire to generate a first predictor. A lookup table or a database stores data for a second predictor. One of the predictors includes at least one vehicle effect. A model receives the predictors and generates an estimated wear rate for the at least one tire.

### FIELD OF THE INVENTION

The invention relates generally to tire monitoring systems. More particularly, the invention relates to systems that collect tire parameter data. The invention is directed to a system and method for estimating tire wear based upon multiple predictors to provide an accurate and reliable estimation.

### BACKGROUND OF THE INVENTION

Tire wear plays an important role in vehicle factors such as safety, reliability, and performance. Tread wear, which refers to the loss of material from the tread of the tire, directly affects such vehicle factors. As a result, it is desirable to monitor and/or measure the amount of tread wear experienced by a tire.

One approach to the monitoring and/or measurement of tread wear has been through the use of wear sensors disposed in the tire tread, which has been referred to a direct method or approach. The direct approach to measuring tire wear from tire mounted sensors has multiple challenges. Placing the sensors in an uncured or “green” tire to then be cured at high temperatures may cause damage to the wear sensors. In addition, sensor durability can prove to be an issue in meeting the millions of cycles requirement for tires. Moreover, wear sensors in a direct measurement approach must be small enough not to cause any uniformity problems as the tire rotates at high speeds. Finally, wear sensors can be costly and add significantly to the cost of the tire.

Due to such challenges, alternative approaches were developed, which involved prediction of tread wear over the life of the tire. These alternative approaches have experienced certain disadvantages in the prior art due to a lack of optimum prediction techniques, which in turn reduces the accuracy and/or reliability of the tread wear predictions.

As a result, there is a need in the art for a system and method that accurately and reliably estimates tire wear.

### SUMMARY OF THE INVENTION

According to an aspect of an exemplary embodiment of the invention, a tire wear estimation system is provided. The system includes at least one tire that supports a vehicle. At least one sensor is affixed to the tire to generate a first predictor. A lookup table or a database stores data for a second predictor. One of the predictors includes at least one vehicle effect. A model receives the predictors and generates an estimated wear rate for the at least one tire.

According to another aspect of an exemplary embodiment of the invention, a method for estimating the wear of a tire supporting a vehicle is provided. The method includes providing at least one sensor that is affixed to the tire. A first predictor is generated from the at least one sensor. At least one of a lookup table and a database is provided to store data. A second predictor is generated from the lookup table or the database. One of the predictors includes at least one vehicle effect. The predictors are input into a model, and an estimated wear rate for the tire is generated with the model. The estimated wear rate is communicated to a vehicle operating system.

### BRIEF DESCRIPTION OF THE DRAWINGS

The invention will be described by way of example and with reference to the accompanying drawings, in which:

FIG. 1 is a perspective view of a vehicle and sensor-equipped tire;

FIG. 2 is a graphical representation showing the effect of wheel position on tread wear;

FIG. 3 is a schematic diagram of vehicle drivetrains and wheel positions;

FIG. 4 is a boxplot showing the relationship of wheel position and tread wear for different drivetrain types;

FIG. 5 is a boxplot showing a comparison of tread wear for driving routes of different severity levels;

FIG. 6 is a graphical representation showing the relationship between tread wear and tire force severity;

FIG. 7 is a graphical representation showing the correlation between tread wear and tire dimensions;

FIG. 8 is a boxplot showing the relationship between tread wear and weather effects;

FIG. 9 is a boxplot showing the relationship between tread wear and tread compound characteristics;

FIG. 10 is a schematic representation of the predictors used in a first exemplary embodiment of the tire wear estimation system and method of the present invention;

FIG. 11 is a graphical representation of the accuracy of an exemplary embodiment of the tire wear estimation system and method of the present invention.

FIG. 12 is a schematic representation of a second exemplary embodiment of the tire wear estimation system and method of the present invention;

FIG. 13 is a schematic representation of integration of data in the second exemplary embodiment of the tire wear estimation system and method of the present invention; and

FIG. 14 is a schematic representation of the implementation of the first and second exemplary embodiments of the tire wear estimation system and method of the present invention.

Similar numerals refer to similar parts throughout the drawings.

### DEFINITIONS

“ANN” or “Artificial Neural Network” is an adaptive tool for non-linear statistical data modeling that changes its structure based on external or internal information that flows through a network during a learning phase. ANN neural networks are non-linear statistical data modeling tools used to model complex relationships between inputs and outputs or to find patterns in data.

“Aspect ratio” of the tire means the ratio of its section height (SH) to its section width (SW) multiplied by 100 percent for expression as a percentage.

“Asymmetric tread” means a tread that has a tread pattern not symmetrical about the center plane or equatorial plane EP of the tire.

“Axial” and “axially” means lines or directions that are parallel to the axis of rotation of the tire.

“CAN bus” is an abbreviation for controller area network.

“Chafer” is a narrow strip of material placed around the outside of a tire bead to protect the cord plies from wearing and cutting against the rim and distribute the flexing above the rim.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact created by the tire tread with a flat surface as the tire rotates or rolls.

“Inboard side” means the side of the tire nearest the vehicle when the tire is mounted on a wheel and the wheel is mounted on the vehicle.

“Kalman Filter” is a set of mathematical equations that implement a predictor-corrector type estimator that is optimal in the sense that it minimizes the estimated error covariance when some presumed conditions are met.

“Lateral” means an axial direction.

“Lateral edges” means a line tangent to the axially outermost tread contact patch or footprint as measured under normal load and tire inflation, the lines being parallel to the equatorial centerplane.

“Luenberger Observer” is a state observer or estimation model. A “state observer” is a system that provide an estimate of the internal state of a given real system, from measurements of the input and output of the real system. It is typically computer-implemented, and provides the basis of many practical applications.

“MSE” is an abbreviation for mean square error, the error between and a measured signal and an estimated signal which the Kalman filter minimizes.

“Net contact area” means the total area of ground contacting tread elements between the lateral edges around the entire circumference of the tread divided by the gross area of the entire tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Outboard side” means the side of the tire farthest away from the vehicle when the tire is mounted on a wheel and the wheel is mounted on the vehicle.

“Piezoelectric Film Sensor” a device in the form of a film body that uses the piezoelectric effect actuated by a bending of the film body to measure pressure, acceleration, strain or force by converting them to an electrical charge.

“PSD” is power spectral density (a technical name synonymous with FFT (fast fourier transform).

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Sipe” means small slots molded into the tread elements of the tire that subdivide the tread surface and improve traction, sipes are generally narrow in width and close in the tires footprint as opposed to grooves that remain open in the tire's footprint.

“Tread element” or “traction element” means a rib or a block element defined by a shape having adjacent grooves.

“Tread Arc Width” means the arc length of the tread as measured between the lateral edges of the tread.

### DETAILED DESCRIPTION OF THE INVENTION

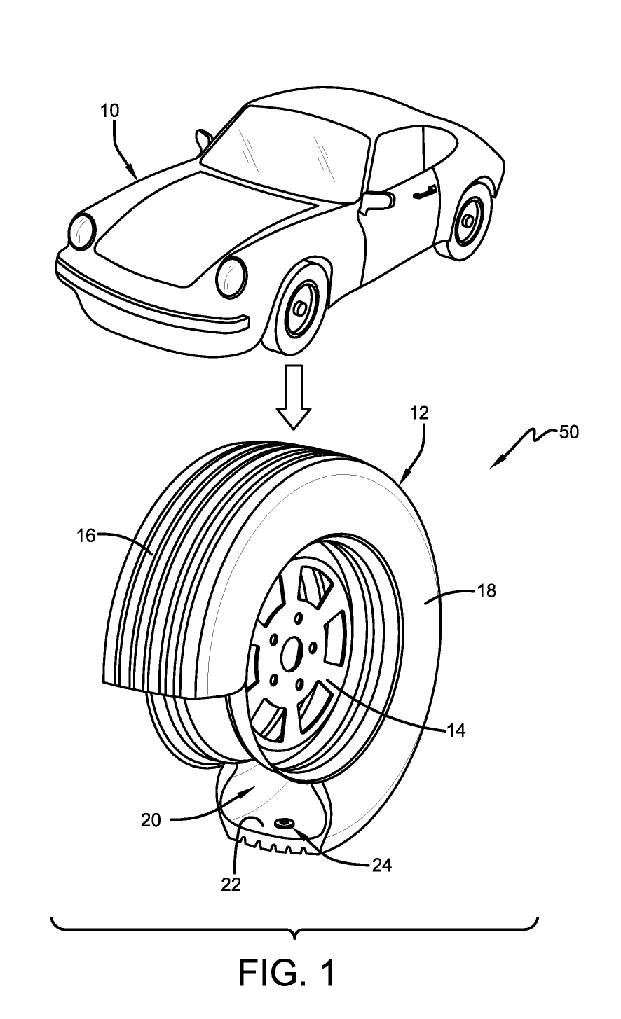

A first exemplary embodiment of the tire wear estimation system of the present invention is indicated at 50 in FIGS. 1 through 11. With particular reference to FIG. 1, the system 50 estimates the tread wear on each tire 12 supporting a vehicle 10. While the vehicle 10 is depicted as a passenger car, the invention is not to be so restricted. The principles of the invention find application in other vehicle categories such as commercial trucks in which vehicles may be supported by more or fewer tires.

The tires 12 are of conventional construction, and are mounted on a wheel 14. Each tire includes a pair of sidewalls 18 that extend to a circumferential tread 16, which wears from road abrasion with age. Each tire 12 preferably is equipped with a sensor or transducer 24 that is mounted to the tire for the purpose of detecting certain real-time tire parameters, such as tire pressure and temperature. The sensor 24 preferably also includes a tire identification (tire ID) for each specific tire 12, and transmits measured parameters and tire ID data to a remote processor, such as a processor integrated into the vehicle CAN bus, for analysis. The sensor 24 may be a tire pressure monitoring (TPMS) module or sensor, and is of a type commercially available. The sensor 24 preferably is affixed to an inner liner 22 of the tire 12 by suitable means such as adhesive. The sensor 24 may be of any known configuration, such as piezoelectric sensors that detect a pressure within a tire cavity 20.

The tire wear estimation system 50 and accompanying method attempts to overcome the challenges posed by prior art methods that measure the tire wear state through direct sensor measurements. As such, the subject system and method is referred herein as an “indirect” wear sensing system and method that estimates wear rate. The prior art direct approach to measuring tire wear state from tire mounted sensors has multiple challenges, which are described above. The tire wear estimation system 50 and accompanying method utilize an indirect approach, and avoid the problems attendant use of tire wear sensors mounted directly to the tire tread 16. The system 50 instead utilizes a tire wear estimation model that receives multiple input parameters to generate a high-accuracy estimation of the rate of tire wear.

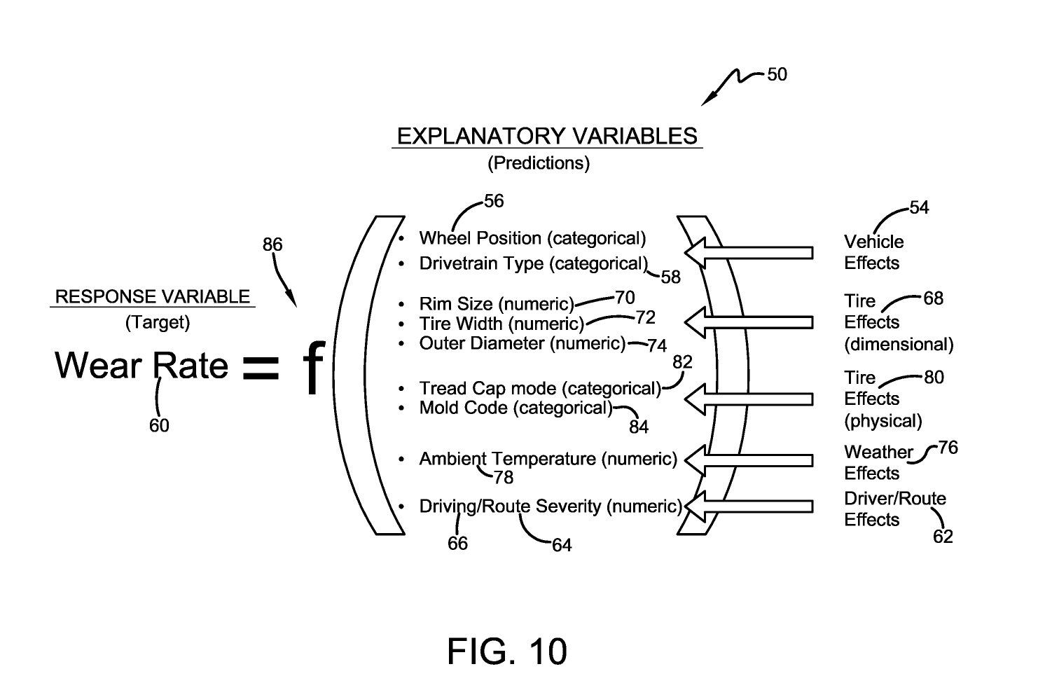

Aspects of the tire wear estimation system 50 preferably are executed on a processor that is accessible through the vehicle CAN bus, which enables input of data from the sensor 24, as well as input of data from a lookup table or a database that is stored in a suitable storage medium and is in electronic communication with the processor. As shown in FIG. 10, the tire wear estimation system 50 employs a wide range of predictors 52 that are input to provide an estimation of tire wear or the tire wear rate 60. It is to be noted that, for the purpose of convenience, the term “tread wear” may be used interchangeably herein with the term “tire wear”.

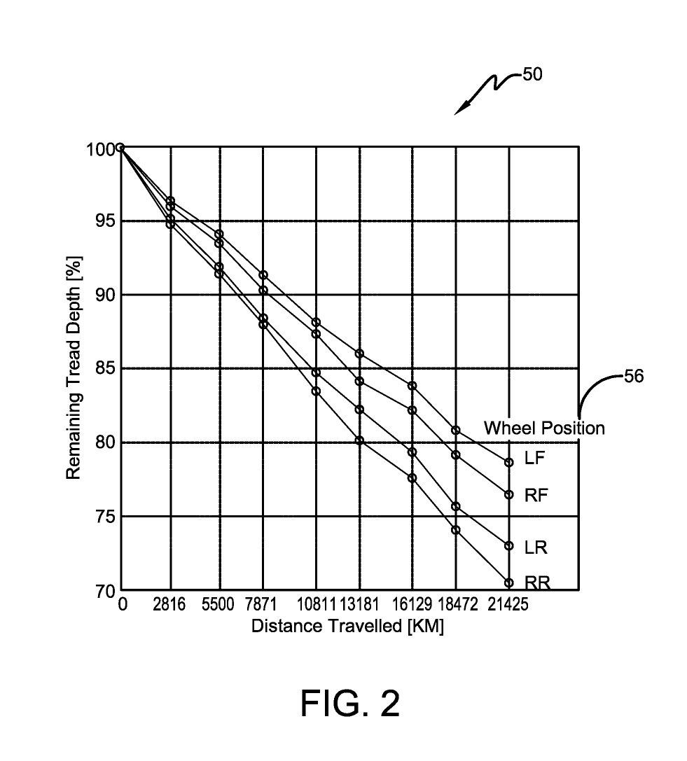

A first one of the predictors 52 for the tire wear estimation system 50 includes vehicle effects 54. More particularly, one vehicle effect 54 is a wheel position 56 on the vehicle 10. The vehicle 10 includes four different wheel positions 56: driver side or left side front, passenger side or right side front, driver side or left side rear, and passenger side or right side rear. The tire 12 at each wheel position 56 experiences a different wear pattern, which leads to different tread wear. For example, as shown in FIG. 2, each wheel position 56 of left front (LF), right front (RF), left rear (LR) and right rear (RR) undergoes different tread wear, as indicated by the tread depth, as the vehicle 10 is driven. Therefore, the wheel position 56 is one of the predictors 52 to be input into the tire wear estimation system 50. The wheel position 56 may be sensed by the sensor 24, may be included in the tire ID data, and/or may be stored in the above-described storage medium.

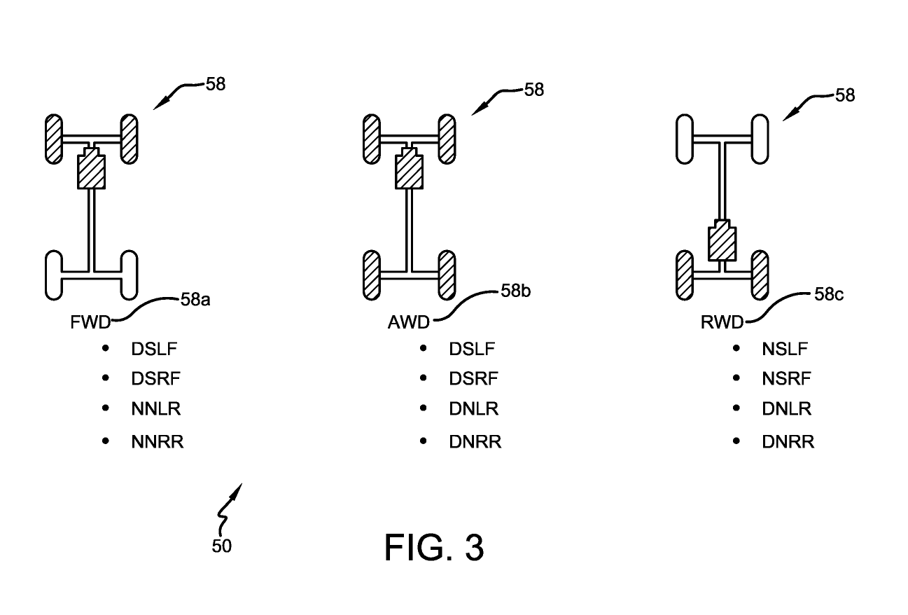

Referring to FIG. 10, another vehicle effect 54 is the vehicle drivetrain type 58. More particularly, the tread wear for the tire 12 at each wheel position 56 becomes more significant when taking the drivetrain type 58 into account. As shown in FIG. 3, there are three different drivetrain types 58: front wheel drive 58a; all wheel drive 58b; and rear wheel drive 58c. Each drivetrain type 58 affects tire wear. In front wheel drive 58a, the front steering axle is driven, so both front tires are driven and steered, while rear tires are not driven or steered. In all wheel drive 58b, the front and rear axles are driven, so the front tires are driven and steered, while the rear tires are driven but not steered. In rear wheel drive 58c, the rear axle driven, so front the tires are steered but not driven, while the rear tires are driven and not steered.

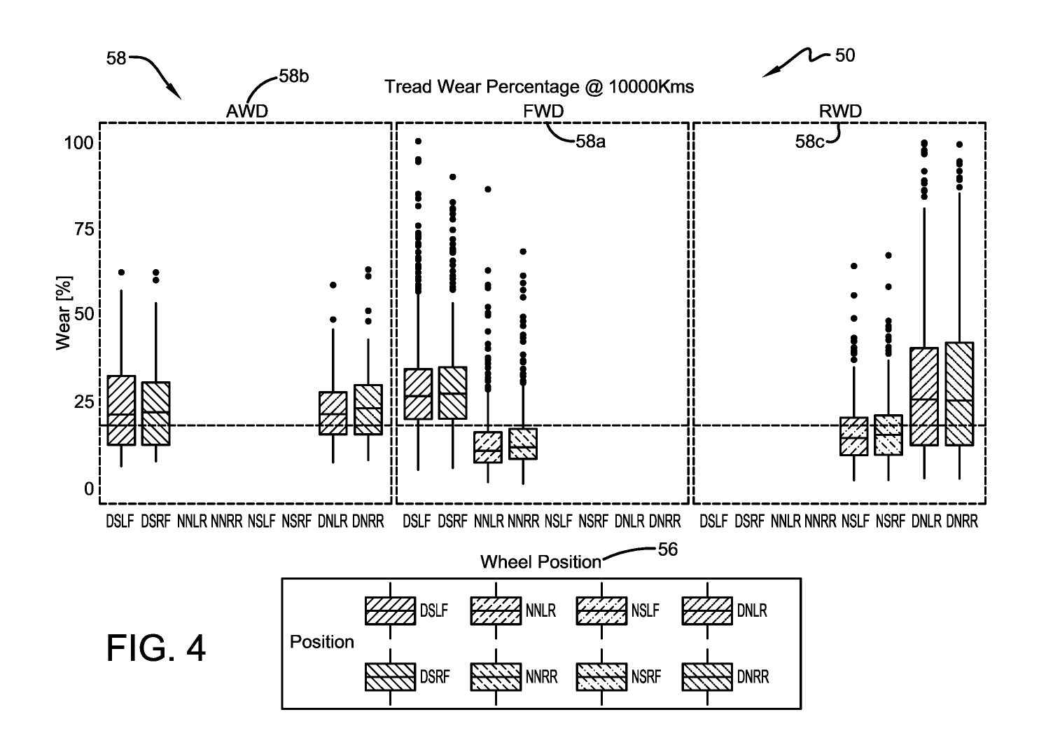

Turning to FIG. 4, a boxplot shows the relationship of the wheel position 56 and the tread wear for different drivetrain types 58. For an all wheel drive drivetrain 58b, there are similar wear rates for tires 12 at all four wheel positions 56. For front wheel drive drivetrains 58a, the wear rates of the front tires are about twice that of the rear tires. For rear wheel drive drivetrains 58c, the wear rates of the rear tires are about 1.5 times that of the front tires. Therefore, the drivetrain type 58 has a significant impact on tire wear, and is one of the predictors 52 to be input into the tire wear estimation system 50. The drivetrain type 58 may be sensed by the sensor 24, may be included in the tire ID data, and/or may be stored in the above-described storage medium.

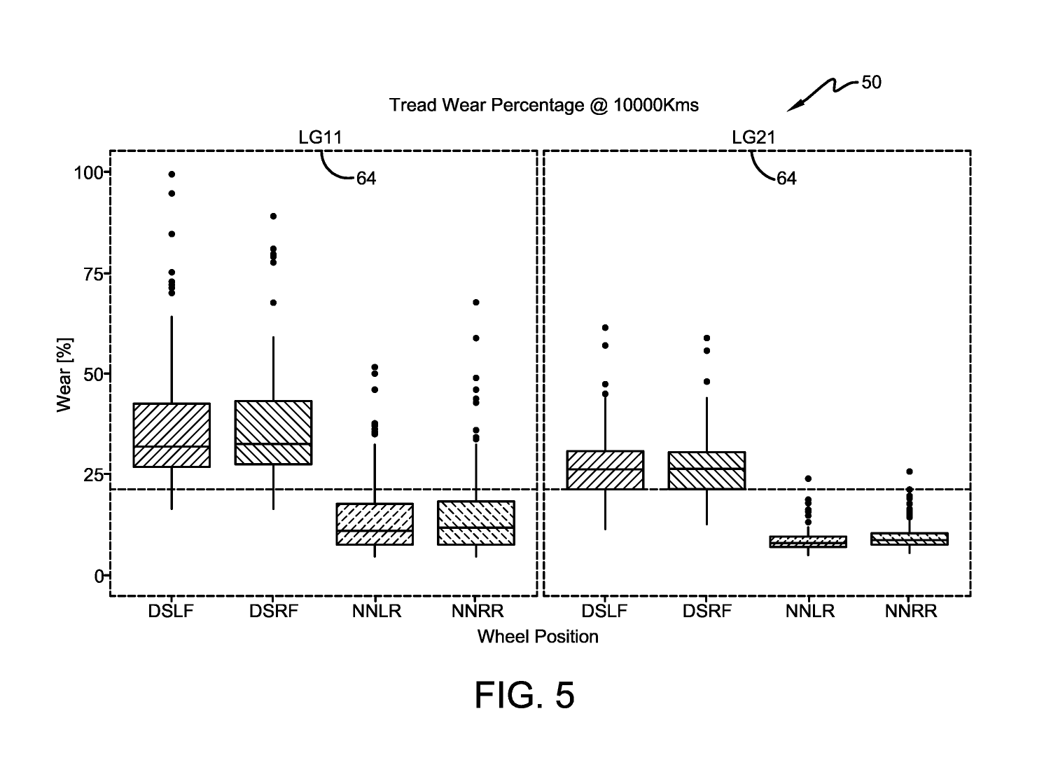

As shown in FIG. 10, a second one of the predictors 52 for the tire wear estimation system 50 includes route and driver effects 62. The route and driver effects 62 in turn include route severity 64 and driver severity 66. The route severity 64 takes into account the amount of turns, starts and stops in a route driven by the vehicle 10. A route that includes more turns, more starts and/or more stops than another route is considered to be more severe, and will thus have a higher route severity 64. FIG. 5 is a boxplot showing a comparison of tread wear for driving routes having two different severity levels. Specifically, route LG11 has a route severity 64 that is higher than route LG21. Because route LG11 has a higher route severity 64, and is thus a more severe route, it results in more wear on the tires 12.

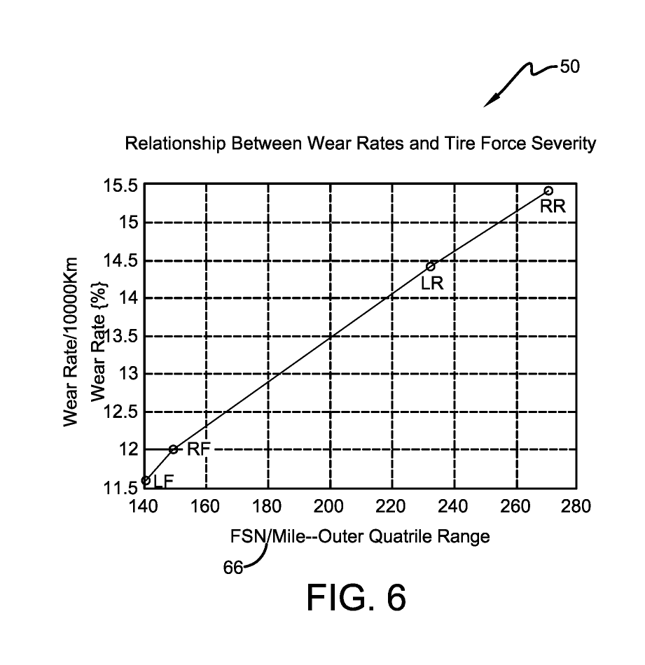

The driver severity 66 takes into account the driving style of the driver of the vehicle 10. More aggressive driving, such as aggressive starts and stops, generates more frictional energy, which increases tire force and increases tread wear. As shown in FIG. 6, the driver severity 66 may be expressed as the force severity on the tire 10. Calculation of the force severity on the tire 10 may be done through a variety of techniques. One exemplary technique is described in U.S. patent application Ser. No. 14/918,928, which is owned by the same assignee as the present invention, The Goodyear Tire & Rubber Company, and is incorporated herein by reference. FIG. 6 is a graphical representation showing the relationship between tread wear and tire force severity, which indicates that a higher driver severity 66 creates more tire wear. The route and driver effects 62 may be sensed by the sensor 24, may be included in the tire ID data, and/or may be stored in the above-described storage medium.

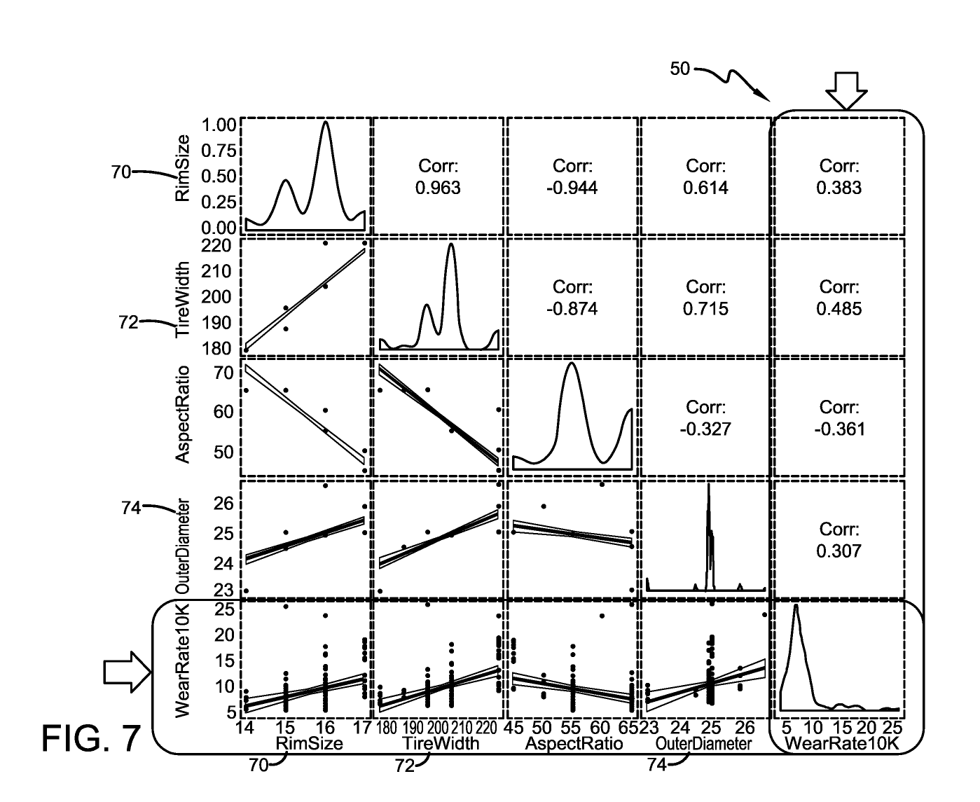

Returning to FIG. 10, a third one of the predictors 52 for the tire wear estimation system 50 includes dimensional tire effects 68. The dimensional tire effects 68 in turn include the tire rim size 70, the tire width 72, and the tire outer diameter 74. FIG. 7 provides a graphical representation showing the correlation between tread wear and dimensional tire effects 68, including the tire rim size 70, the tire width 72, and the tire outer diameter 74. This correlation establishes that tire size affects wear rate, as larger tires tend to wear more. Therefore, the dimensional tire effects 68 comprise one of the predictors 52 to be input into the tire wear estimation system 50. The dimensional tire effects 68 may be sensed by the sensor 24, may be included in the tire ID data, and/or may be stored in the above-described storage medium.

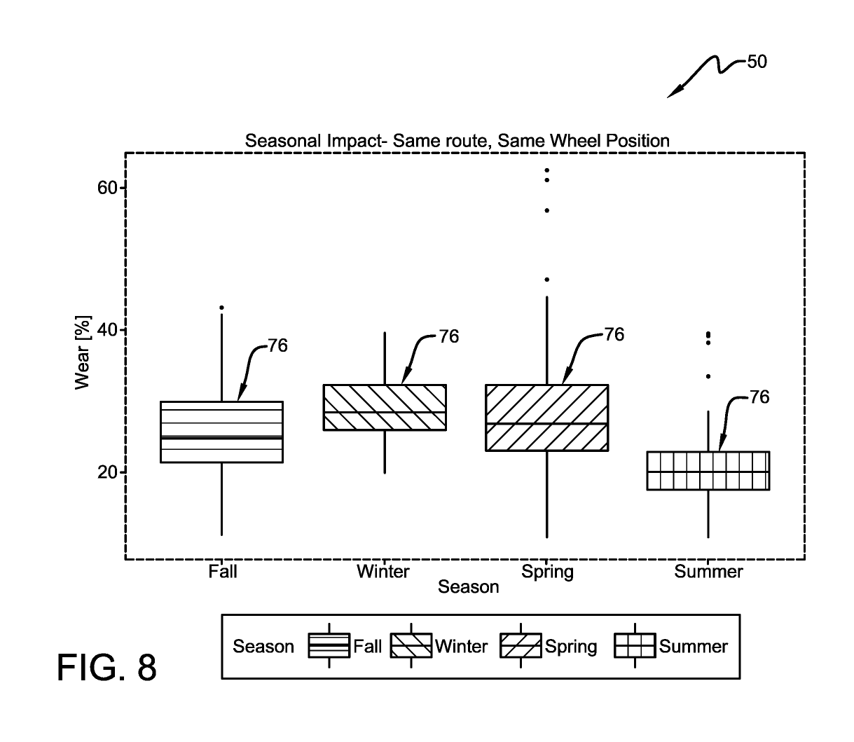

A fourth one of the predictors 52 for the tire wear estimation system 50, as shown in FIG. 10, includes weather effects 76. FIG. 8 is a boxplot showing the relationship between tread wear and weather effects 76. From the boxplot, it is evident that higher wear rates occur in seasons with lower temperatures. Therefore, a convenient indicator of weather effects 76 is an ambient temperature 78. Higher wear rates thus occur at lower ambient temperatures 78. The ambient temperature 78 preferably is sensed by the sensor 24 for input into the tire wear estimation system 50.

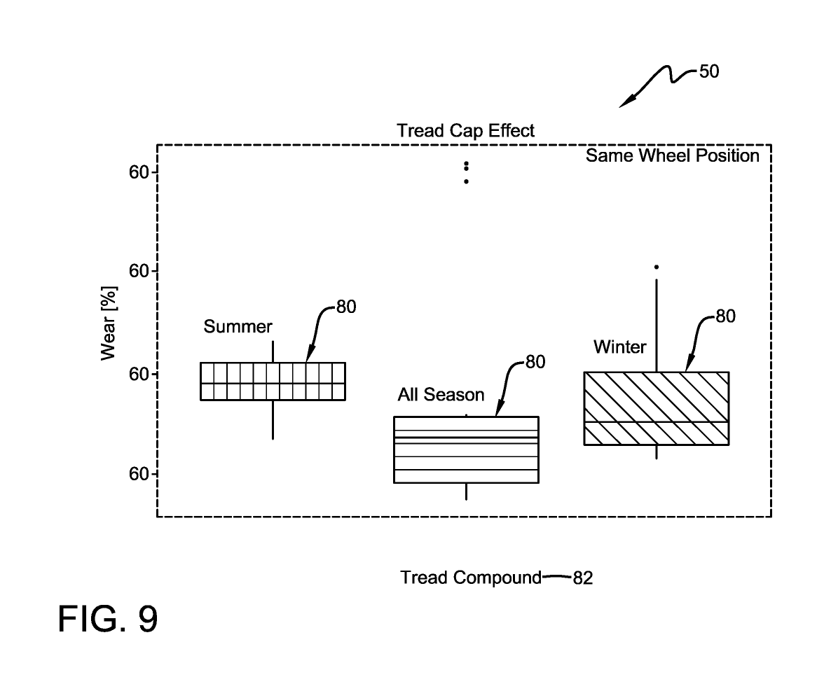

With reference again to FIG. 10, a fifth one of the predictors 52 for the tire wear estimation system 50 includes physical tire effects 80. The physical tire effects 80 in turn include the compound used for the tread 16, which may be indicated by the treadcap code 82, and the tread structure, which may be indicated by the tire mold code 84. For example, FIG. 9 is a boxplot showing the relationship between tread wear and different types of tread compounds 82. As shown by FIG. 9, the characteristics of a particular tread compound 82 affect wear, as do the characteristics of a particular tread structure 84. Therefore, physical tire effects 80 comprise one of the predictors 52 to be input into the tire wear estimation system 50. The physical tire effects 80 may be included in the tire ID data and/or may be stored in the above-described storage medium.

Other predictors 52 may optionally be employed in the tire wear estimation system 50. For example, tire pressure as sensed by the sensor 24 may be used as a predictor 52, as low pressure, known as under-inflation, and excessive pressure, known as over-inflation, may impact the wear rate of the tire 12. The roughness of the road driven by the vehicle 10 may impact tire wear, and may thus be employed as a predictor 52 and sensed by the sensor 24 and/or stored in the above-described storage medium. Also, scrubbing of the tires 12, which is a dragging of a tire in a lateral direction due to short turns or parking lot maneuvers, may accelerate tire wear, and may be sensed by the sensor 24 and used as a predictor 52.

Referring now to FIG. 10, all of the predictors 52 are input into a model 86 to generate the estimated wear rate 60 for a given tire 12. The tire wear estimation system 50 generates the estimated wear rate 60 through model fitting, and any appropriate model may be selected. For example, a Multiple Linear Regression (MLR) Model may be used. By way of background, linear regression is a simple approach to supervised learning. It assumes that the dependence of Y on X1; X2; . . . Xp is linear. In this example, the model is:

Y=β₀+β₁X₁+β₂X₂+. . . +βₚXₚ+ε,

We interpret βⱼ as the average effect on Y of a one unit increase in Xᵢ, holding all other predictors fixed.

The model fitting is done using stepwise regression, in turn using a forward selection technique, with p-value criteria. Regression subset selection is performed using a forward stepwise selection technique. In this technique, one starts with a model having no predictors, that is, the model is built with only the intercept. The independent variable with the lowest p-value or the highest F value is chosen, and the remaining variables are added one at a time to the existing model. The variable with the lowest significant p-value is selected. This step is repeated until the lowest p-value is greater than 0.05. To summarize, the procedure is to start with the most basic model, Y=β0 and add one predictor at a time until there is no statistically significant difference between adding one more predictor.

Of course, any suitable modeling technique known to those skilled in the art may be used without affecting the concept or operation of the invention. Once the estimated wear rate 60 is generated, it is communicated from the tire wear estimation system 50 to the vehicle operating systems, such as braking and stability control systems, through the vehicle CAN bus.

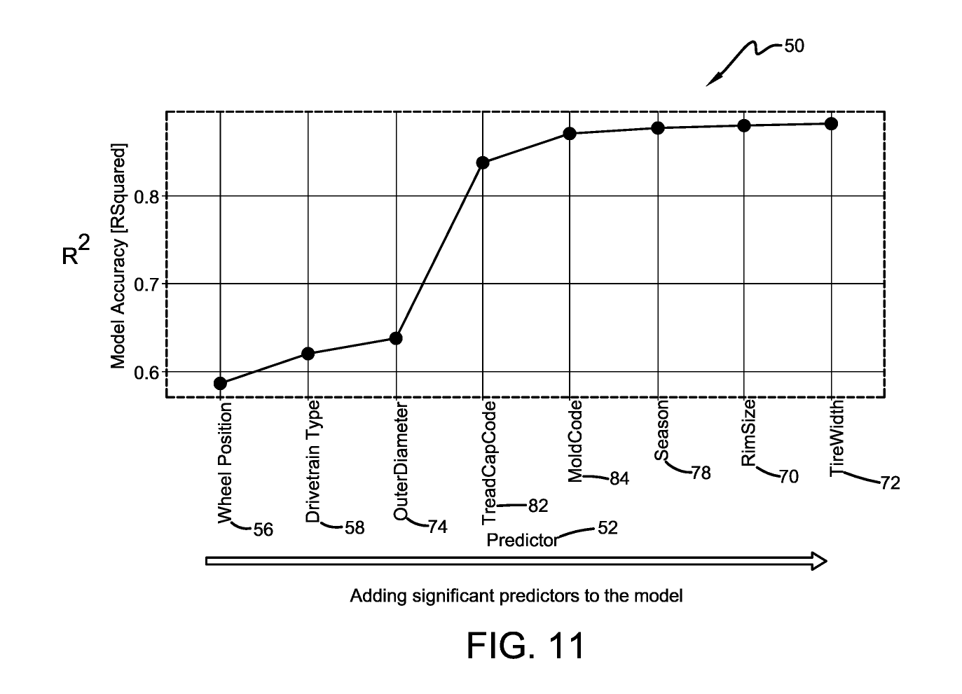

Turning to FIG. 11, a graphical representation of the accuracy of an exemplary embodiment of the tire wear estimation system 50 of the present invention is shown. The use of the model 86 with multiple input predictors 52 achieves over 85% accuracy in wear estimation, which indicates an accurate and reliable estimate of the tire wear rate 60. In this manner, the tire wear estimation system 50 of the present invention employs multiple predictors to accurately and reliably measure tire wear.

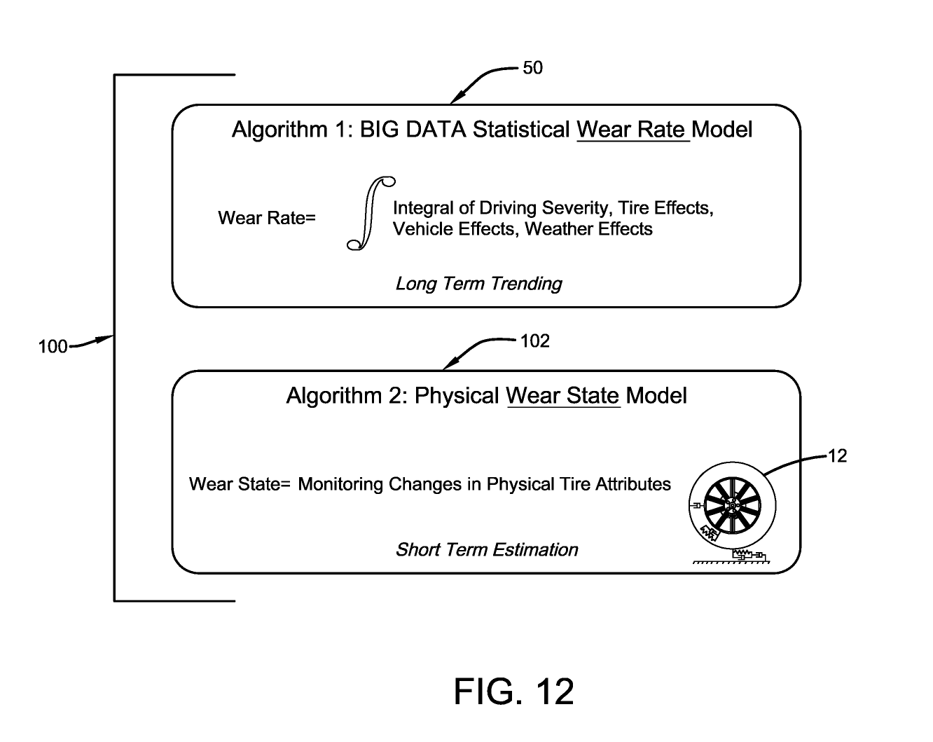

A second exemplary embodiment of the tire wear estimation system of the present invention is indicated at 100 in FIGS. 12 through 14. With particular reference to FIG. 12, the second embodiment of the tire wear estimation system 100 incorporates the first embodiment of the wear estimation system 50 as described above, and adds certain real-time predictors 102. More particularly, the first embodiment of the wear estimation system 50 is an indirect wear sensing system and method that utilizes a tire wear estimation model which receives multiple input parameters or predictors 52 to generate a high-accuracy estimation of the rate of tire wear. The second embodiment of the wear estimation system 100 adds predictors 102 that include real-time measurements of sensed conditions of the tire 12.

Such real-time measurements include changes in the physical attributes or characteristics of the tire, such as the stiffness of the tread 16. Real-time measurement and modeling of such physical attributes or characteristics may be accomplished through techniques known to those skilled in the art.

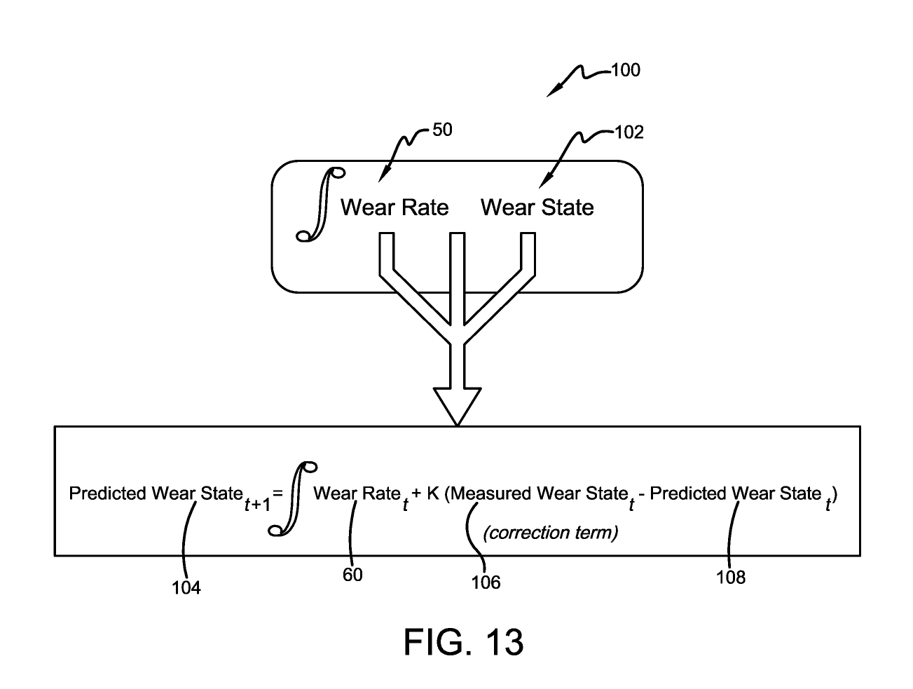

As shown in FIG. 13, when the first embodiment the first embodiment of the wear estimation system 50 is integrated with the real-time predictors 102, a predicted wear state 104 is calculated. The predicted wear state 104 includes the above-described wear rate 60 with the addition of corrected real-time predictors, which include the measured wear state parameters 106 with filter adjustments 108. Specifically, the filter adjustments 108 subtract or remove data that may generate “noise” or inaccurate values.

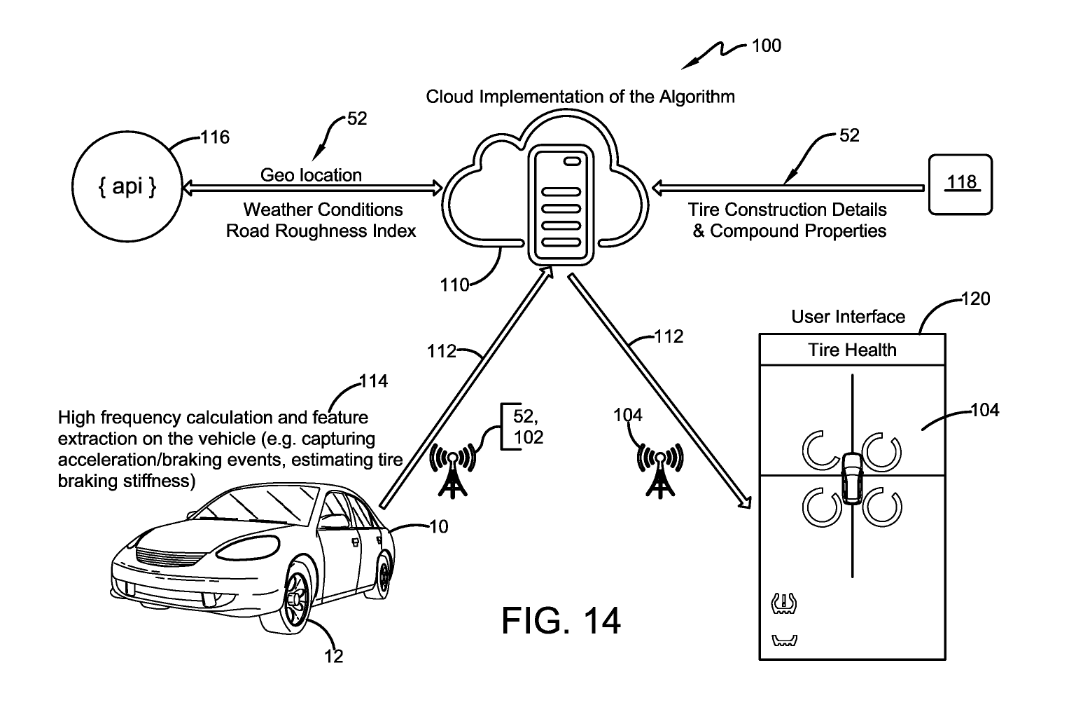

Turning to FIG. 14, the second embodiment of the wear estimation system 100 may be implemented using a cloud-based server 110. More particularly, sensors on the tire 12 and/or the vehicle 10 are a first source 114 that measure real-time predictors 102, which are wirelessly transmitted by means known in the art 112 to the server 110. The tire sensor 24 may also transmit certain selected predictors 52, such as the ambient temperature 78 and tire identification data, to the server 110. Other selected predictors 52 for estimation of the wear rate 60, such as location, weather, and road condition data, may be transmitted from a second source 116 to the server 110. Still other selected predictors 52 for estimation of the wear rate 60, such as tread compound data 82 and tread structure data 84, may be sent from a third source 118 to the server 110. On the server 110, the predictors 52 are input into the model 86 for estimation of the wear rate 60, which is integrated with the real-time predictors 102 to yield the predicted wear state 104. The predicted wear state 104 is wirelessly transmitted by means known in the art 112 to a device 120 for display to a user or a technician, such as a smartphone.

In this manner, the second embodiment of the wear estimation system 100 provides additional refinement and accuracy, as it adds the predictors 102 of real-time measurements of sensed conditions of the tire 12 to the estimation of the wear rate 60 that is generated by the first embodiment of the wear estimation system 50.

The present invention also includes a method of estimating the wear rate of a tire 12. The method includes steps in accordance with the description that is presented above and shown in FIGS. 1 through 14.

It is to be understood that the structure and method of the above-described tire wear estimation system may be altered or rearranged, or components or steps known to those skilled in the art omitted or added, without affecting the overall concept or operation of the invention.

The invention has been described with reference to preferred embodiments. Potential modifications and alterations will occur to others upon a reading and understanding of this description. It is to be understood that all such modifications and alterations are included in the scope of the invention as set forth in the appended claims, or the equivalents thereof.

What is claimed is:

1. A tire wear estimation system comprising:
at least one tire supporting a vehicle;
at least one sensor affixed to the tire to generate a first predictor;
at least one of a lookup table and a database storing data for a second predictor;
one of the predictors including at least one vehicle effect; and
a model receiving the predictors and generating an estimated wear rate for the at least one tire.

2. The tire wear estimation system of claim 1, wherein the model generates the estimated wear rate on a processor that is accessible through a vehicle CAN bus.

3. The tire wear estimation system of claim 1, further comprising means for communicating the estimated wear rate to a vehicle operating system.

4. The tire wear estimation system of claim 1, wherein the first predictor includes weather effects.

5. The tire wear estimation system of claim 4, wherein the first predictor is an ambient temperature.

6. The tire wear estimation system of claim 1, wherein the at least one vehicle effect includes at least one of a wheel position of the at least one tire and a drivetrain type of the vehicle.

7. The tire wear estimation system of claim 1, further comprising an additional predictor that includes at least one of route severity and driver severity.

8. The tire wear estimation system of claim 1, further comprising an additional predictor that includes at least one of a rim size of the at least one tire, a width of the at least one tire, and an outer diameter of the at least one tire.

9. The tire wear estimation system of claim 1, further comprising an additional predictor that includes at least one of a compound identification for the at least one tire and a tread structure identification for the at least one tire.

10. The tire wear estimation system of claim 9, wherein the compound identification is expressed in a treadcap code.

11. The tire wear estimation system of claim 9, wherein the tread structure identification is expressed in a mold code.

12. The tire wear estimation system of claim 1, further comprising additional predictors that include at least one of a pressure of the at least one tire, a road roughness, and tire scrubbing incidents.

13. The tire wear estimation system of claim 1, wherein the model includes a multiple regression linear model.

14. The tire wear estimation system of claim 1, further comprising an additional predictor that includes a real-time measurement of a sensed physical condition of the at least one tire, and the model integrates the real-time measurement with the estimated wear rate.

15. A method for estimating the wear of a tire supporting a vehicle, the method comprising the steps of:
providing at least one sensor affixed to the tire;
generating a first predictor from the at least one sensor;
providing at least one of a lookup table and a database storing data;
generating a second predictor from the at least one of a lookup table and a database, wherein one of the predictors includes at least one vehicle effect;
inputting the predictors into a model;
generating an estimated wear rate for the tire with the model; and
communicating the estimated wear rate to a vehicle operating system.

16. The method for estimating the wear of a tire of claim 15, wherein the first predictor includes an ambient temperature.

17. The method for estimating the wear of a tire of claim 15, wherein the at least one vehicle effect includes at least one of a wheel position of the tire and a drivetrain type of the vehicle.

18. The method for estimating the wear of a tire of claim 15, further comprising providing an additional predictor that includes at least one of route severity and driver severity.

19. The method for estimating the wear of a tire of claim 15, further comprising providing an additional predictor that includes at least one of a rim size of the at least one tire, a width of the at least one tire, and an outer diameter of the at least one tire.

20. The method for estimating the wear of a tire of claim 15, further comprising providing an additional predictor that includes at least one of a compound identification for the at least one tire and a tread structure identification for the at least one tire.

21. The method for estimating the wear of a tire of claim 15, further comprising providing additional predictors that include at least one of a pressure of the at least one tire, a road roughness, and tire scrubbing incidents.

22. The method for estimating the wear of a tire of claim 15, further comprising sensing a real-time measurement of a physical condition of the tire and integrating the estimated wear rate with the sensed physical condition.
